(19) United States
(12) Patent Application Publication
(10) Pub. No.: US 2023/0061329 A1
(43) Pub. Date: Mar. 2, 2023

(54) SWEETENER COMPOSITION

(71) Applicant: CARGILL, INCORPORATED, Wayzata, MN (US)

(72) Inventors: Abdelfattah BENSOUISSI, Vilvoorde (BE); Michael FOUCAULT, Vilvoorde (BE); Nick VAES, Vilvoorde (BE)

(73) Assignee: CARGILL, INCORPORATED, Wayzata, MN (US)

(21) Appl. No.: 17/905,958

(22) PCT Filed: Mar. 9, 2021
(86) PCT No.: PCT/US2021/021567

§ 371 Date: Sep. 9, 2022

(30) Foreign Application Priority Data
Mar. 9, 2020 (EP) 20161754.5

(51) Int. Cl. A23L 33/125; A23L 33/21; A23L 29/30

(52) U.S. Cl. CPC A23L 33/125; A23L 33/21; A23L 29/30

(57) ABSTRACT

The present invention relates to a sweetener composition and a process for preparing a sweetener composition. In particular, the present invention relates to a sweetener composition comprising a crystalline carbohydrate and a bulking agent for replacing all or part of the sugar in a food product. The bulking agent can be selected from soluble and insoluble fibres.

### CROSS-REFERENCE TO RELATED APPLICATIONS

This application claims the benefit of European Patent Application No. 20161754.5, filed Mar. 9, 2020, which is hereby incorporated by reference in its entirety.

### FIELD OF THE INVENTION

The present invention relates to a sweetener composition and a process for preparing a sweetener composition. In particular, the present invention relates to a sweetener composition comprising a crystalline carbohydrate and a bulking agent for replacing all or part of the sugar in a food product.

### BACKGROUND

There is an increasing preference amongst consumers for “healthier” food products containing less sugar and/or calories than conventional food products. This has created a high demand for low sugar and low calorie or non-calorie alternatives.

Sugar, typically sucrose, is widely used as a food ingredient and serves several functions. Most importantly, it provides sweetness. It also provides bulk and plays a significant role in the structure, volume and mouthfeel of the finished food product. Formulating foods without sugar is challenging because a sugar replacement must fulfil all these various functions and perhaps more.

One approach has been to replace sugar with high-intensity sweeteners. However, such sweeteners can negatively impact flavour by causing a perceived “off-taste” and/or “aftertaste” and would require a substantial amount of bulking agent as the high intensity sweetener will not bring any texture to the product where it is added. Polyols have also been used for sugar replacement, however they are typically less sweet than sugar and at high dosages can have negative gastrointestinal side effects.

Bulking agents including starches or fibres have also been used to replace part of the sugar content in food. However, the use of bulking agents has been known to reduce sweetness.

WO2017093302, WO2017093309, WO2018100059, WO2018224546, WO2018224539, WO2018224534, WO2018224534, WO2018224537, WO2018224546, WO2018224542, and WO2018224541 disclose sugar replacers comprising amorphous porous particles and processes of preparing the amorphous porous particles for use in food and beverage products. The amorphous porous particles comprise sweetener, a bulking agent, and optionally a surfactant. However, these amorphous porous particles have a number of disadvantages. For example, they are thermodynamically unstable resulting in inconsistent product quality and poor shelf-life. They are also very hygroscopic leading to increased instances of lumping and stickiness, which in turn leads to difficulties with storage, packaging, and processing (e.g. milling, spray drying). This last property has to be countered by cooling the product and placing it in a water-proof container immediately after drying, and also by using dehumidified air during processing. The manufacturing process for the particles is generally not cost-effective, for example because it involves dissolving the particles in water and then spray drying to remove the water, spray drying being an expensive process. The porous nature of the particles also causes them to hold fat, meaning that fat-based food products, such as chocolate, which contain the particles can have increased calorie content, and may therefore be considered less healthy.

There remains a need for a composition which can be used to replace all or part of the sugar in food, and which avoids or ameliorates the aforementioned disadvantages. The present invention seeks to fulfil this need.

The sweetener composition of the present invention has a number beneficial characteristics that make it superior to the amorphous porous particles described above. From the perspective of an ingredient manufacturer, the process for manufacturing the sweetener composition of present invention is better because it is simple, cost-effective, and easy to implement, is more sustainable (reduced use of water, reduced need for drying), and results in a stable, shelf-stable, product that can be easily packaged. From the perspective of a food product manufacturer, the sweetener composition of the present invention is an easier ingredient to process because it has low stickiness, meaning that there is less need for frequent cleaning of equipment and machines, less product losses, and storage under standard conditions in a warehouse prior to use is made possible.

In use, the sweetener composition has similar sweetness and texture/mouthfeel to pure sugar at a comparable weight whilst providing an advantageous reduction in calories increased fibre content, and a reduced particle size that makes it particularly suitable for use in high quality chocolates, but also in other cocoa-containing compositions (coatings, fillings, powdered beverages etc.).

### STATEMENTS OF INVENTION

In one aspect, the present invention provides a process for preparing a sweetener composition comprising dry blending one or more crystalline carbohydrate(s) and one or more bulking agent(s) to obtain a sweetener composition having a D90 particle size of 150 microns or less, optionally 30 microns or less.

Optionally, the process further comprises subjecting the carbohydrate(s) and/or the bulking agent(s) to a particle size reduction technique before dry blending or simultaneously with dry blending. The particle size reduction technique may be milling and/or micronization, and optionally may be cryogenic.

Optionally, the carbohydrate is selected from the group consisting of monosaccharides, disaccharides, and polyols. Advantageously, the carbohydrate is sucrose.

Optionally, the bulking agent comprises insoluble and/or soluble fibre. The insoluble fibre may be selected from the group consisting of dietary fibre, cereal bran, oat fibre, bamboo fibre, fruit fibres, sugar beet fibre, sugar cane fibre, tomato fibre, coconut fibre, straw from cereals such as wheat or barley, pea fibre, tea, coffee, potato fibre, cocoa, cocoa powder, bran waste, sugar waste, cocoa waste, corn-cob waste, cellulose, hemi-cellulose (for example from elephant grass), chitosan, pectins, gums, mucilages, lignins, compositions comprising the same or combinations thereof. The soluble fibre may be selected from the group consisting of resistant dextrin, resistant/modified maltodextrin, polydextrose, β-glucan, galactomannan, fructo-oligosaccharides, gluco-oligosaccharide, galacto-oligosaccharides, MOS (mannose-oligosaccharides), pectin, psyllium, inulin, resistant starch, compositions comprising the same or combinations thereof. Advantageously, the bulking agent comprises or consists of soluble fibre selected from the group consisting of resistant dextrin.

Optionally, the process further comprises adding an anti-caking agent.

Advantageously, the sweetener composition does not comprise a surface active agent.

Advantageously, the sweetener composition consists essentially of non-porous particles.

Advantageously, the sweetener composition consists of or essentially consists of bulking agent and crystalline carbohydrate. Advantageously, the sweetener composition consists of or essentially consists of one bulking agent and one (partially) crystalline carbohydrate.

In another aspect, the present invention provides a sweetener composition obtained or obtainable by the process.

In another aspect, the present invention provides a sweetener composition.

In another aspect, the present invention provides a food product comprising the sweetener composition.

In another aspect, the present invention provides the use of the sweetener composition as a sugar replacer in a food product.

### DESCRIPTION OF THE FIGURES

FIG. 1 displays an image obtained from an electron microscope of Blend 1, a dry blend of resistant dextrin and silk sugar.

FIG. 2 displays an image obtained from an electron microscope of Blend 2, a dry blend of micronized exhausted cocoa powder and silk sugar.

FIG. 3 displays an image obtained from an electron microscope of Blend 3, a dry blend of micronized wheat bran and silk sugar.

FIG. 4 displays an image obtained from an electron microscope of Blend 4, a dry blend of micronized cocoa shells and silk sugar.

FIG. 5 displays an image obtained from an electron microscope of Blend 5, a dry blend of micronized corn bran and silk sugar.

FIG. 6 displays an image obtained from an electron microscope of Blend 6, a dry blend of micronized crystalline cellulose and silk sugar.

FIG. 7 shows the correlation between sweetness and the absence of off-taste in Blends 1 to 6 of the examples below.

### DETAILED DESCRIPTION

Unless otherwise specified, all terms should be accorded a technical meaning consistent with the usual meaning in the art as understood by the skilled person.

All ratios and percentages in the present description correspond to dry weight percent unless otherwise specified.

All parameter ranges include the end-points of the ranges and all values in between the end-points, unless otherwise specified.

When used in this specification and claims, the terms “comprises” and “comprising” and variations thereof mean that the specified features, steps or integers are included. The terms are not to be interpreted to exclude the presence of other features, steps or components.

The term “sugar” is used herein to refer generally to naturally occurring sugars that are traditionally used in food production, especially baking and confectionary making. Typically “sugar” means sucrose, but other naturally occurring monosaccharides and disaccharides and mixtures thereof are also meant to be included by this term.

As used herein, the term “sweetener composition” is used to refer to a combination of ingredients that may be used to impart sweetness to a food product. The sweetener composition of the present invention may be used to wholly or partly replace sugar (e.g. sucrose, lactose etc.) in a recipe for a food product thereby reducing the total sugar content of the food product. As sugar is high in calories, this replacement also reduces the total calorie content of the food product.

The sweetener composition of the present invention comprises one or more “bulking agent(s)”. Bulking agents may be selected to fulfil some of the functions of sugar and/or because of their individual chemical and physical properties which may affect the organoleptic or rheological properties of the food. In the context of the present invention, the term “bulking agent” is synonymous with the term “filler”. Any suitable bulking agent known in the art may be used in accordance with the present invention. Advantageously, the bulking agent is fibre, including soluble and/or insoluble fibre. General health advice encourages a diet high in fibre, so the use of fibre as a food ingredient might be particularly attractive to health conscious consumers. Moreover, the use of insoluble fibre is a sustainable alternative, as these are often obtained from by-products in the food industry.

Non-limiting examples of “insoluble fibre” that may be used in accordance with the present invention are dietary fibre, cereal bran, oat fibre, bamboo fibre, fruit fibre, sugar beet fibre, sugar cane fibre, tomato fibre, coconut fibre, straw from cereals such as wheat or barley, pea fibre, tea, coffee, potato fibre, cocoa, cocoa powder, bran waste, sugar waste, cocoa waste, corn-cob waste, cellulose, hemi-cellulose (for example from elephant grass), chitosan, pectins, gums, mucilages, lignins, compositions comprising the same or combinations thereof. Insoluble fibres, such as wheat bran, can be obtained in micronized form having reduced particle size, for use in the present invention.

Non-limiting examples of “soluble fibre” that may be used in accordance with the present invention are resistant dextrin, such as Promitor® grades from Tate & Lyle, Nutriose® grades from Roquette, and Fibersol® grades from ADM/Mitsutani, resistant/modified maltodextrin, polydextrose (such as Litesse®), β-glucan, galactomannan, fructo-oligosaccharides, gluco-oligosaccharide, galacto-oligosaccharides, MOS (mannose-oligosaccharides, also known in the art as mannan-oligosaccharides or manno-oligosaccharides), pectin, psyllium, inulin, resistant starch, compositions comprising the same or combinations thereof. The soluble fibre may for example be Nutriose® from Roquette. The resistant dextrin or polydextrose can also be obtained according to the process described in WO2011/091962, which is incorporated herein by reference. The soluble fibre can also be a MOS obtainable according to the processes described in WO2018/232078, which is incorporated herein by reference.

Advantageously, the bulking agent comprises or consists of soluble fibre selected from the group consisting of resistant dextrin.

Advantageously, the bulking agent comprises
soluble fibre selected from the group consisting of resistant dextrin and
one or more insoluble or
one or more other soluble fibres.
   Including resistant dextrin as a bulking agent soluble can be surprisingly advantageous to maintain good sensory characteristics of the sweetener composition, comparable to a full sugar reference.

To improve the efficiency of the process of the invention when using soluble fibres, it is preferred that the soluble fibre when prepared is dried to the right granulometry to avoid the need for further particle size reduction at a later stage.

Insoluble and soluble fibre may be used in any combination in the sweetener compositions and the processes of preparing the sweetener compositions according to the present invention.

The sweetener composition of the present invention also comprises one or more “crystalline carbohydrate(s)”.

The term “crystalline” is used herein to mean that at least 50% of the carbohydrate (as defined below) has a crystalline (i.e. non-amorphous) structure. Advantageously, around 100% (for example, at least 99% 98%, 97% 96%, or 95%) of the carbohydrate molecules are crystalline, meaning that the carbohydrate is free or essentially free of amorphous regions. Using currently available crystallization techniques it is expected that a trace amount of amorphous material may still be present. According to the present invention, the bulking agent preferably will not crystallize. It is not excluded that the size reduction step results in a minor amorphization of the crystalline sugar.

“Crystallization”, i.e. the formation of crystals, occurs in two major steps. The first step is nucleation, which is the spontaneous formation of small solid particles (i.e. crystals) in a liquid solution, melt, or paste. Nucleation is influenced inter alia by the temperature and concentration of the solution. Nucleation may be assisted by adding a “seed”, or it may be unseeded. The second step is crystal growth, which is where the particles formed in the nucleation step increase in size. Growth rate is influenced by several factors, including but not limited to the surface tension of the solution, pressure, temperature, and relative crystal velocity in the solution. As used herein, the term “crystallization” may refer to nucleation and/or crystal growth.

The term “carbohydrate” as used herein refers to any type of carbohydrate that may crystallise and which is suitable for use in food. Non-limiting examples of carbohydrates that may be used in the present invention include monosaccharides, such as glucose, fructose, allulose or galactose; disaccharides such as sucrose, lactose or maltose; and polyols such as sorbitol, mannitol, maltitol, xylitol, erythritol, or isomalt. Advantageously, the carbohydrate is sucrose.

The term “sucrose” as used herein includes sucrose in various solid forms including but not limited to standard (e.g. granulated) table sugar, powdered sugar, caster sugar, icing sugar, sugar syrup, unrefined sugar, raw sugar cane. Advantageously, the sweetener composition comprises silk sugar, such as the silk sugar manufactured by British Sugar Plc. Silk sugar is an ultrafine sugar preferably having a D90 particle size of less than 30 μm, or less than 25 μm, or 20 μm or less. Silk sugar may have a D50 particle size of less than 15 μm, or less than 10 μm, or less than 9 μm, or 8 μm or less. More preferably, silk sugar has a D90 particle size of 20 μm and a D50 particle size of 8 μm.

According to the present invention particle size, i.e. granulometry, is defined using D90. The D90 value is a common method of describing a particle size distribution. “D90” refers to the value of the maximum particle dimension (for example, the diameter for a generally spherical particle) where 90% of the volume of the particles in the sample have a maximum particle dimension below that value. In other words, in a cumulative distribution of the maximum particle dimension in a sample of particles, 90% of the distribution lies below the D90 value.

“Maximum dimension” or “maximum particle dimension” refers to the longest cross-sectional dimension of any particular particle, e.g. a carbohydrate crystal, a particle of bulking agent, or particle of the final sweetener composition.

The D90 value may be measured for example by a laser light diffraction/scattering particle size analyser as described further below. Other known measurement techniques for particle size may also be used depending on the nature of the sample. The D90 value of powders may conveniently be measured by digital image analysis (such as using a CAMSIZER XT® as sold by Retsch GmbH) while the D90 value of particles comprised within a fat continuous material such as chocolate may be measured by laser light scattering. Particle size may be measured using any known method using suitable equipment. One device that is commonly used is a Malvern Mastersizer 3000 as sold by Malvern Panalytical Ltd.

For context, regular crystalline sugar (i.e. table sugar) has a D90 particle size of approximately 1000 microns. Icing sugar has a D90 particle size of approximately 150 microns. Refined sugar used in chocolate making typically has a D90 particle size of approximately, 30 microns. Silk sugar has a D90 particle size of less than 30 microns, or less than 25 microns, or less than 20 microns, or preferably less than 20 microns.

The sweetener composition of the present invention has a D90 particle size of 150 microns or less. Advantageously, the D90 particle size is 125 microns or less, or 100 microns or less, or 75 microns or less, or 50 microns, or 40 microns or less, or 30 microns or less, or 20 microns or less, or 10 microns or less. Preferably, the particle size of the sweetener composition is approximately the same as that of silk sugar. The lower limit of the particle size is greater than zero, but may be negligible depending on the limit of detection of the equipment used to measure the particle size.

Without wishing to be bound by theory, the relatively small particle size of the sweetener composition of the present invention (as indicated by the D90 value) means that the sugar which is part of the sweetener composition can dissolve more quickly in the oral cavity than coarse sugar. This rapid dissolution leads to an enhanced perception of sweetness because it means that more of the sweetener composition is tasted by the tongue before being swallowed. Thus, the sweetener composition can be used to boost the sweetness of a food product when used as a sugar replacer. This effect unexpectedly counteracts any reduction in sweetness that may be expected due to the presence of bulking agents in the sweetener composition. The relatively small particle size also provides good mouthfeel to the final product as the composition will not be perceived as gritty or grainy in texture.

The sweetener composition is preferably in the form of a “dry” or “semi-dry” free flowing powder having a water content of 5 wt % or less, or 3 wt % or less, or 2 wt % or less, or 1 wt % or less, or 0.5 wt % or less.

The crystalline carbohydrate(s) and bulking agent(s) respectively may be present in the sweetener composition in an amount by weight according to the ratio of carbohydrate(s):bulking agent(s) of 99:1, or 98:2, or 97:3, or 96:4, or 95:5, or 90:10, or 85:15, or 80:20, or 75:25, or 70:30, or 65:35, or 60:30, or 55:45, or 50:50, or 45:55, or 40:60, or 35:65, or 30:60, or 25:75, or 20:80, or 15:85, or 10:90, or 5:95, or 4:96, or 3:97, or 2:98, or 1:99. The crystalline carbohydrate(s) and bulking agent(s) may also be present in the sweetener composition in an amount by weight within a range formed by a combination of the end points from any two of the above list of ratios.

The crystalline carbohydrate(s) may be present in the sweetener composition in an amount of 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, or 1% by weight. The crystalline carbohydrate(s) may also be present in the sweetener composition in an amount by weight within a range formed by a combination of any two values from the above list of percentages. Preferably, the crystalline carbohydrate is present in the sweetener composition in an amount sufficient to provide the desired sweetness to the relevant food product.

The bulking agent(s) may be present in the sweetener composition in an amount of 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, or 1% by weight. The bulking agent(s) may also be present in the sweetener composition in an amount by weight within a range formed by a combination of any two values from the above list of percentages.

The sweetener composition may also comprise additional ingredients. For example, the composition may comprise an anti-caking or free flowing agent including but not limited to a silica based agent, calcium stearate, magnesium stearate, and/or extra dry starch. Other additives may include flavouring agents, colourants, and/or masking agents.

Advantageously, the sweetener composition of the present invention does not comprise any surface active agents, i.e. “surfactants”. The term surfactant is used herein to refer to a compound that lowers the surface tension or interfacial tension between particles. Surfactants may also act as detergents, wetting agents, emulsifiers, foaming agents and/or dispersants. The use of surfactants can be undesirable if they are of a type that is required by law to be listed on food labels as consumers are increasingly demanding “clean-label” food products.

The particles that make up the sweetener composition of the present invention are preferably non-porous, meaning that they are not hollow. The sweetener composition may consist, or essentially consist, of non-porous particles. The use of porous particles is disadvantageous where a sweetener composition is to be used in a food product that comprises fat because the fat will be at least partially absorbed into the hollow space inside the particles. This can negatively affect the processing of the product and may necessitate a higher fat content to counterbalance this effect. The use of non-porous particles in the sweetener composition of the present invention thus enables the production of relatively low fat food products which may be more desirable to health conscious consumers.

Advantageously, the sweetener composition consists of or essentially consists of one or more bulking agents e.g. soluble fibre, such as resistant dextrin, and one or more crystalline carbohydrates, e.g. sucrose. Advantageously, the sweetener composition consists of or essentially consists of one bulking agent e.g. soluble fibre, such as resistant dextrin, and one crystalline carbohydrate, e.g. sucrose. The bulking agent can be selected from soluble fibres, in particular resistant dextrin, and the crystalline carbohydrate can be selected from sucrose.

Also provided is a process for preparing a sweetener composition in accordance with the present invention. The process comprises dry blending one or more crystalline carbohydrate(s) and one or more bulking agent(s) to obtain the sweetener composition.

“Dry blending” is a technique used to mix multiple dry components to form a homogenous dry product, e.g. a powder. According to the present invention, dry blending may be carried out by means of any suitable equipment known in the art. A non-exhaustive list of types of devices that can be used may include ribbon blenders, paddle blenders, vertical blenders, tumble blenders, and thermal screws. A Henschel Mixer® is a commonly used food mixer for dry blending. Dry blending may be carried out under low, medium, or high shear, and is carried out for an amount of time sufficient to obtain a homogeneous composition. A minor amount of liquid may be added during the dry blending process, for example to coat the particles or provide colouring, flavouring, or other additives.

The crystalline carbohydrate(s) and bulking agent(s) that are dry blended in accordance with the present invention may have a D90 particle size of 150 microns or less to result in a sweetener composition having this desired particle size. Advantageously, the D90 particle size of the crystalline carbohydrate(s) and bulking agent(s) is 125 microns or less, or 100 microns or less, or 75 microns or less, or 50 microns or 40 microns or less or 30 microns or less 20 microns or less. The lower limit of the particle size is greater than zero, but may be negligible depending on the limit of detection of the equipment used to measure the particle size.

The crystalline carbohydrate(s) and bulking agent(s) that are dry blended may be size reduced particles, meaning that they have been subjected to a particle size reduction technique to achieve the desired particle size before dry blending.

Alternatively, the process of the invention may further comprise subjecting the carbohydrate(s) and/or the bulking agent(s) to a particle size reduction technique to achieve the desired particle size. Any particle size reduction technique that is known in the art may be used in accordance with the present invention, such as milling, micronization, grinding, extrusion, high pressure homogenization, abrasion, fractionation, or pulverizing. A combination of particle size reduction techniques may also be used.

Any known milling method may be used in accordance with the present invention. For example, ball-milling, wet-ball milling, or micro-milling in an impact mill.

Micronization may be used to provide very fine particles (e.g. less than 100 microns). Micronization methods are known in the industry. For example WO2017/167965, which is incorporated herein by reference, describes a micronized “bran-like” material. Micronization involves heat-treating the material and then milling at high speed (e.g. at least 3000 rpm) using a high performance mill, such as a cell mill or jet mill. The mill can further include a classifier to circulate coarse material back into the mill for further milling.

A cell mill is a highly efficient mechanical mill with multiple rotors mounted on a vertical shaft. Product quality is optimised by control of mill speed through a frequency inverter, which also limits the starting current. A cell mill results in two product streams, standard (or product) and oversize, the standard stream is the preferred output that may comprise micronized bran of the invention.

A jet mill (also known as a microniser) typically comprises a spiral jet which uses compressed gas to produce superfine materials by autogenous comminution. Feed material is inspirated by a small proportion of the compressed gas through a venturi into the grinding chamber where numerous angles nozzles accelerate the material into particle-particle impact. There are no moving parts in the mill and no mechanical forces are applied to the grinding process. Variation in gas pressure and residence time is possible.

The particle size reduction technique may be cryogenic. Cryogenic techniques are particularly useful where there is a need to control or reduce the stickiness of the particles.

Advantageously, the particle size reduction technique may be carried out before dry blending or simultaneously with dry blending. In some instances size reduction may be carried out after dry blending.

The particle size reduction technique may also include size classification and/or separation steps (e.g. sieving or sifting). For example a TTC/TTD Air Classifier® or Mikro® Acucut Air classifier model sold by Hosokawa Micron Powder Systems may be used.

As described above, additional ingredients may be added to the sweetener composition of the invention. These may be added at any time during the preparation process, including adding them to the starting materials before dry blending, during the dry blending step, or after the dry blending step (i.e. blending with the final sweetener composition).

The sweetener composition of the present invention may be used in the manufacture of a food product. In particular, it may be used to wholly or partially replace the sugar in a recipe for a food product (i.e. it may be used as a “sugar replacer”). The term “replace” is not intended to be construed such that sugar must be removed from a food product before adding the sweetener composition of the invention, rather it is meant that the sweetener composition is used instead of all or part of the sugar that would otherwise be used when manufacturing the food product. When used as a sugar replacer, the sweetener composition may be used to replace up to 10%, or up to 20%, or up to 30%, or up to 40%, or up to 50%, or up to 60%, or up to 70%, or up to 80%, or up to 90%, or up to 100% of the sugar in the food product by weight. The sweetener composition may be present in the food product in an amount by weight within a range formed by a combination of any two values from the above list of percentages. Advantageously, the present invention provides replacement of sugar in a food product whilst still achieving comparable levels of sweetness, similar levels of sweetness, or enhanced levels of sweetness and preferably still maintaining similar texture and mouthfeel of sugar.

The food product may be a confectionary product, a culinary product, a dairy product, a nutritional formula, a breakfast cereal (including flapjacks, cereal bars, and extruded cereal based products and co-extruded filled cereal based products), a baked product, and/or animal food. Confectionary products are foodstuffs which are predominately sweet in flavour and are not predominately baked. Exemplary confectionary products include, but are not limited to, fat-based confectionary products, such as chocolate, chocolate-like material, fat-continuous filling material and frozen confectionary, such as ice cream and combinations thereof, for instance chocolate coating of frozen confectionary or chocolate pieces within frozen confectionary. Further examples of confectionary products include, but are not limited to, non-fat-based confectionary products, sweets, candies, gummies, sugar confections, tablets, treats, toffees, boiled sweets, bonbons, candy-floss, caramel, fudge, liquorice, marshmallow, nougat, truffle, fondant, ganache etc. Baked products are, or comprise components which are, predominately baked and may be sweet or savoury and may comprise baked grain foodstuffs. Exemplary baked products can comprise baked cereals and/or pulses such as baked wheat foodstuffs, such as bread, rolls, cakes, pastries, crumpets, scones, pancakes, pies, gingerbreads, biscuits, wafers, and/or cookies etc. The food product according to the present invention may be the entire food product or it may part of a food product such as a filling, binder, a shell or coating, inclusion or decoration for a food product. The food product may also be a multi-layered foodstuff optionally comprising a plurality of layers of baked foodstuff, wafer or biscuit and at least one filling layer located between the layers of baked foodstuff, wafer or biscuit the filling layer comprising a fat based confectionery composition. Any combination of the above alternatives is also encompassed by the present invention. Advantageously, the food product has a relatively low water content, such as 5 wt % or less, or 4 wt % or less, or 3 wt % or less, or 2 wt % or less, or 1 wt % or less.

The term “chocolate” is used herein to mean any product (and/or component thereof) that meets a legal definition of chocolate in any jurisdiction (preferably the US and/or EU) and also includes any product (and/or component thereof) in which all or part of the cocoa butter is replaced by cocoa butter equivalents/replacers/or substitutes. The chocolate may be of a dark, milk, or white variety. The term “chocolate-like material” is used herein to mean chocolate-like analogues characterized by presence of cocoa solids (which include cocoa liquor/mass, cocoa butter and cocoa powder) in any amount, notwithstanding that in some jurisdictions compound may be legally defined by the presence of a minimum amount of cocoa solids and/or compounds that comprise cocoa butter, cocoa butter equivalents, cocoa butter replacers and/or cocoa butter substitutes.

### Materials and Methods

### Measuring D90 Particle Size

The particle size distribution of a sample may be measured by laser light diffraction, for example using a Mastersizer 3000 system (Malvern). This equipment allows the measurement of particles with sizes ranging from 0.1-3500 microns. The system includes a:
Helium Neon red laser (633 nm, max 4 mW) along with a 10 mW 470 nm blue LED light source and a wide angle detection system (0.015-144 degrees).
Hydro MV medium volume automated liquid sample dispersion unit or Hydro SM manual liquid sample dispersion unit for measurements in liquid (Oil, solvents, water)
Aero S automated dry powder dispersion system with a venturi disperser.

Prior to sample measurement a background measurement (duration 10 s or longer) may be carried out.

Preferred settings for measurements:
Particle type: non-spherical
Particle optical parameters: Refractive index (RI) and Absorption index (AI) of the sample.
Calculation: Mie theory
Optical parameters of background medium: Refractive index (RI) Absorption index (AI) of the medium: Air for powder measurement, dispersant for measurements in liquid.

As mentioned earlier, the machine is equipped with two different modules enabling the measurement of particles size distribution in dry or dispersed in liquid. The choice of the method (dispersion in air or in liquid) depends on the particles' capability to disperse in air or in a liquid. The choice of the dispersion media should not affect the size and/or the shape of the particles. In the present invention the dispersion mediums used are air in the case of the Aero S module and oil in the case of the Hydro SM module.

Preferred settings of the measurement with the Aero S module:
Feed rate: 0-100% (optimized to obtain obscuration range 0.5-15%)
Air pressure: 0-3 bar
Obscuration: range 0.5-15%
Amount of sample: 1-20 g of sample is added to the venturi dispenser
Measurement duration: time needed to measure the whole sample that was added to the venturi dispenser

Settings of the measurement with the Hydro SM module:
Obscuration: range 2-20%—Sample is added to the liquid sample dispersion unit until
the obscuration is in range (See table 1)
Stirring speed: 1000-3000 rpm
Measurement duration: 10 s or longer

TABLE 1
Obscuration settings for Mastersizer 3000 system

| SIZE | OBSCURATION |
|---|---|
| very fine (<1 μm) | <5% |
| fine (1-100 μm) | 5-10% |
| coarse (1000 μm) | 10-20% |
| very polydisperse | 10-20% |
| (>1000 μm) | |

The volumetric particles size distribution is calculated from the intensity profile of the scattered light with the Mie theory by use of the software accompanying the machine. The following parameters, among others, are automatically generated by the software:
D [v,0.1]: is the volume diameter where 10% of the volume distribution is below this value (D [v,0.1]).
D [v,0.5]: is the volume median diameter where 50% of the volume distribution of the particles is above and 50% is below this value (D [v,0.5]).
D [v,0.9]: is the volume diameter where 90% of the volume distribution is below this value (D [v,0.9]). This is the D90 particle size in accordance with the present invention.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

### EXAMPLES

### 1. Milling and Dry-Blending

Various samples of bulking agents were prepared for dry-blending. Where necessary the samples were milled down to a D90 of less than 40 microns.

| | |
|---|---|
| Resistant dextrin made | A resistant dextrin syrup was spray dried |
| with spray drying | to directly obtain a powder having a D90 |
| | of less than 100 microns |
| Micronized Exhausted | Obtainable from Prova SAS, France, and |
| cocoa powder (ECP) | milled to get a D90 below 40 microns |
| | using a pin mill from Jehmlich |
| Micronized Cocoa | Obtainable from GreenField, Poland as |
| shells (MCS) | “Cocoa fiber M20” which had a |
| | D90 below 40 microns |
| Micronized Wheat | Wheat bran was micronized to obtain |
| Bran (MWB) | a D90 below 40 microns using a |
| | Hosokawa Jet mill |
| Micronized corn | Corn bran obtained from Limagrain |
| bran (MCB) | Ingredients was micronized to |
| | obtain a D90 below 40 microns |
| | using a Hosokawa Jet mill |
| Microcrystalline | Vivapur ® 105 obtainable from |
| cellulose (MCC) | Rettenmaier. It had a D90 of |
| | below 40 microns. |

These were then dry-blended with silk sugar, an ultrafine crystalline milled sugar with a D50 of less than 8 microns. A standard blender, a Henschel Mixer®, was used for dry blending the materials until a homogenous dry blend of powder was obtained.

The blends prepared contained 50 wt % of bulking agent and 50 wt % of silk sugar. The resulting blends all had a D90 of less than 30 microns.

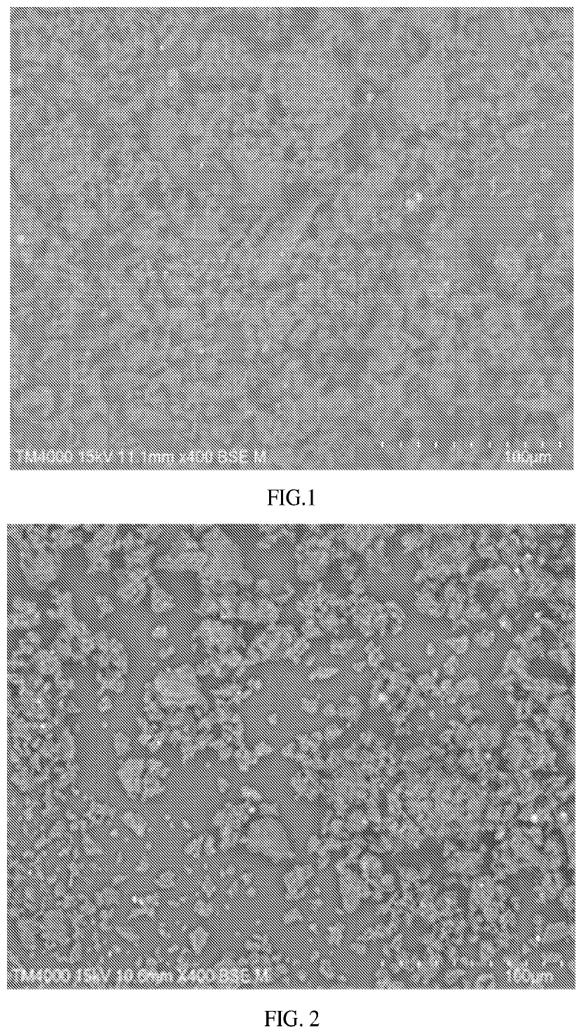

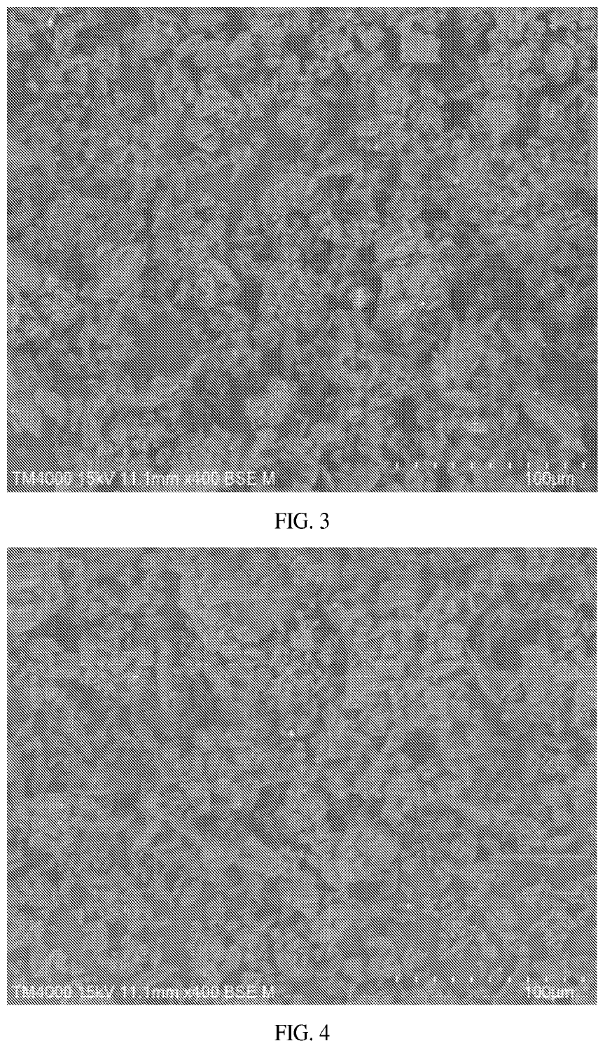

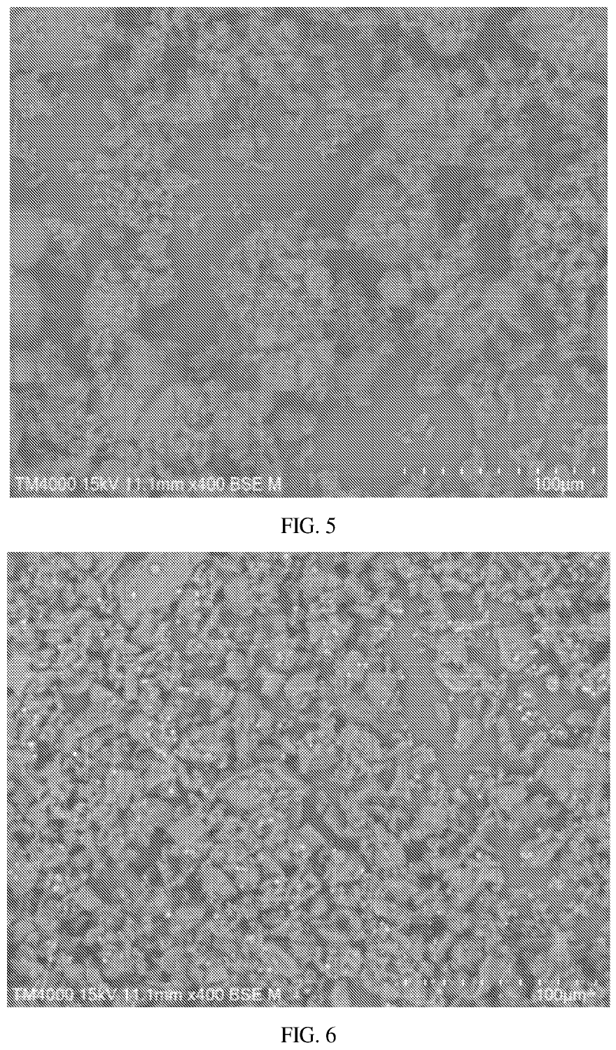

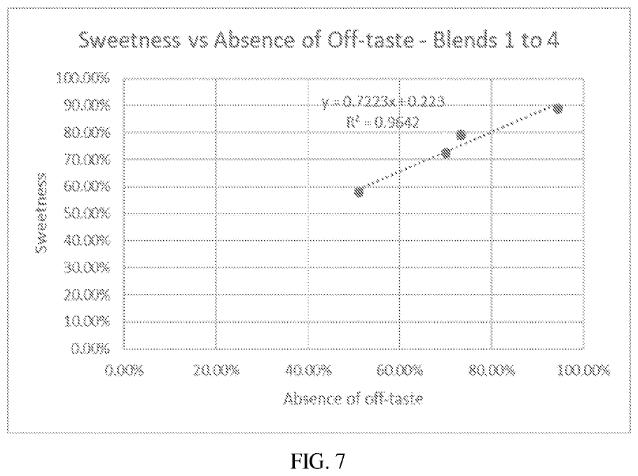

The table below summarizes the different blends that were tested.

| | | | | | | Blend 6 |
|---|---|---|---|---|---|---|
| | Blend 1 | Blend 2 | Blend 3 | Blend 4 | Blend 5 | Micronized |
| | Resistant | Exhausted | Micronized | Micronized | Micronized | crystalline |
| | dextrin | Cocoa powder | wheat bran | cocoa shells | corn bran | cellulose |
| Bulking | <100 | <40 | <40 | <40 | <40 | <40 |
| agent D90 | | | | | | |
| (μm) | | | | | | |
| Silk sugar | <20 | <20 | <20 | <20 | <20 | <20 |
| D90 (μm) | | | | | | |
| Ratio Silk | 50/50 | 50/50 | 50/50 | 50/50 | 50/50 | 50/50 |
| Sugar wt %/ | | | | | | |
| Bulking | | | | | | |
| agent wt % | | | | | | |
| Dry-blend | <30 | <30 | <30 | <30 | <30 | <30 |
| of silk | | | | | | |
| sugar and | | | | | | |
| bulking | | | | | | |
| agent D90 | | | | | | |
| (μm) | | | | | | |
| Electron | FIG. 1 | FIG. 2 | FIG. 3 | FIG. 4 | FIG. 5 | FIG. 6 |
| microscope | | | | | | |
| figure | | | | | | |

FIGS. 1 to 6 show the electron microscopies of the Blends 1 to 6 respectively.

### 2. Preparing Refined Fat-Based Fillings Using the Blends of the Invention

A reference full sugar fat-based chocolate filling was prepared according to the following recipe:

### Reference Filling

| Ingredients | In wt % |
|---|---|
| Icing sugar | 45.5 |
| Skimmed milk powder | 12 |
| Cocoa powder | 8 |
| Fat blend | 34 |
| Vanilla flavour | 0.1 |
| Lecithin | 0.5 |

| Nutritional profile | |
|---|---|
| Carbohydrates (in wt %) | 52.5 |
| Of which sugars (in wt %) | 51.6 |
| Protein (in wt %) | 6.1 |
| Fat (in wt %) | 35.4 |
| Fibre (in wt %) | 2.5 |
| Energy (kcal) | 558.8 |

Sugar-reduced fat-based fillings using the Blends 1-4 as described above were prepared according to the invention and are provided in the recipes below.

### Blend Filling 1

| Ingredients | In wt % |
|---|---|
| Icing sugar (and silk sugar from blend 1) | 27.3 |
| Resistant dextrin | 18.2 |
| Skimmed milk powder | 12.0 |
| Cocoa powder | 8.0 |
| Fat blend | 34.0 |
| Vanilla flavour | 0.1 |
| Lecithin | 0.5 |

| Nutritional profile | |
|---|---|
| Carbohydrates (in wt %) | 51.6 |
| Of which sugars (in wt %) | 34.7 |
| Protein (in wt %) | 6.1 |
| Fat (in wt %) | 35.4 |
| Fibre (in wt %) | 16.5 |
| Energy (kcal) | 527.2 |
| SUGAR REDUCTION | 32.7 |
| compared to reference (%) | |

### Blend Filling 2

| Ingredients | In wt % |
|---|---|
| Icing sugar (and silk sugar from blend 2) | 29.7 |
| Exhausted cocoa powder | 17.7 |
| Skimmed milk powder | 12.0 |
| Cocoa powder | 8.0 |
| Fat blend | 32.0 |
| Vanilla flavour | 0.1 |
| Lecithin | 0.5 |

| Nutritional profile | |
|---|---|
| Carbohydrates (in wt %) | 39.0 |
| Of which sugars (in wt %) | 36.0 |
| Protein (in wt %) | 10.3 |
| Fat (in wt %) | 35.5 |
| Fibre (in wt %) | 9.6 |
| Energy (kcal) | 536.7 |
| SUGAR REDUCTION | 30.4 |
| compared to reference (%) | |

### Blend Filling 3

| Ingredients | In wt % |
|---|---|
| Icing sugar (and silk sugar from blend 3) | 29.4 |
| Micronized wheat bran | 16.1 |
| Skimmed milk powder | 12.0 |
| Cocoa powder | 8.0 |
| Fat blend | 34.0 |
| Vanilla flavour | 0.1 |
| Lecithin | 0.5 |

| Nutritional profile | |
|---|---|
| Carbohydrates (in wt %) | 40.1 |
| Of which sugars (in wt %) | 36.0 |
| Protein (in wt %) | 8.5 |
| Fat (in wt %) | 36.2 |
| Fibre (in wt %) | 10.5 |
| Energy (kcal) | 539.7 |
| SUGAR REDUCTION | 30.2 |
| compared to reference (%) | |

| Ingredients | In wt % |
|---|---|
| Icing sugar (and silk sugar from blend 4) | 30.0 |
| Micronized cocoa shells | 15.5 |
| Skimmed milk powder | 12 |
| Cocoa powder | 8 |
| Fat blend | 34 |
| Vanilla flavour | 0.1 |
| Lecithin | 0.5 |

| Nutritional profile | |
|---|---|
| Carbohydrates (in wt %) | 37.4 |
| Of which sugars (in wt %) | 36.1 |
| Protein (in wt %) | 8.5 |
| Fat (in wt %) | 36.1 |
| Fibre (in wt %) | 12.5 |
| Energy (kcal) | 534 |
| SUGAR REDUCTION | 30.0 |
| compared to reference (%) | |

### 3. Method of Preparing the Fat-Based Fillings

In a first step, the dry ingredients were weighed out and mixed together. A partial amount of the fat blend was added.

Roll-refining of the mixture was carried out on a Buhler SDY-200. The target size after roll-refining was a D90 of 22-25 microns.

The remaining fat and lecithin emulsifier were then added and mixed until homogeneous.

### 4. Rheological Properties

The table below shows the yield stress measured on the 4 different Blend Fillings 1 to 4. Blend Filling 1 using the resistant dextrin in the dry-blend with sugar provides the Casson yield stress closest to the reference. Casson (Infinite shear) viscosity was also measured. Both Casson Yield and Casson (infinite shear) Viscosity were measured according to the IOCCC 2000 method calculated on the 4th interval.

| | Casson Yield | Casson (infinite |
|---|---|---|
| Sample | Stress (Pa) | shear) Viscosity (Pa · s) |
| REFERENCE FILLING | 7.9 | 1.2 |
| (full sugar) | | |
| BLEND FILLING 1 | 5.8 | 1.4 |
| (with resistant dextrin) | | |
| BLEND FILLING 2 | 2.6 | 1.4 |
| (with ECP) | | |
| BLEND FILLING 3 | 4.4 | 1.9 |
| (with MWB) | | |
| BLEND FILLING 4 | 4.9 | 1.6 |
| (with MCS) | | |

The DSC of each blend was also evaluated to test for the presence of crystallinity. All blends retained a high level of crystallinity.

### 5. Sensory Results

A panel of 9 tasters evaluated the sensory properties of the Blend Fillings 1 to 4 in comparison with the full sugar Reference Filling in a blind tasting session. The samples were given a score of 1 to 5 (5 being the most similar to the reference) for the following sensory attributes:
Texture (melting in mouth, graininess; mouth coating; stickiness)
Off-taste (any bitter, wheaty, alcohol, burnt or other unpleasant after taste)
Sweetness (onset, intensity and duration)

A score of 5 was given to the reference on all 3 sensory attributes. The score out of 5 was then calculated as a percentage for all the results obtained on the fillings according to the invention.

| | | Absence | | |
|---|---|---|---|---|
| | | of Off- | | Reference |
| | Texture | taste | Sweetness | score |
| BLEND FILLING 1 | 87.8% | 94.4% | 88.9% | 100.0% |
| (with resistant dextrin) | | | | |
| BLEND FILLING 2 | 78.9% | 70.0% | 72.2% | 100.0% |
| (with ECP) | | | | |
| BLEND FILLING 3 | 83.3% | 73.3% | 78.9% | 100.0% |
| (with MWB) | | | | |
| BLEND FILLING 4 | 83.3% | 51.1% | 57.8% | 100.0% |
| (with MCS) | | | | |

It can be seen here that the dry blend of the resistant dextrin with the silk sugar performed the best overall. What was highly unexpected is that the texture, off-taste and sweetness sensory results did not decrease by 30%, although the amount of sugar reduction was always at around 30-32% in each recipe. The dry-blend of the bulking agent with the silk sugar is surprisingly good at replacing 30 wt % or more of sugar in a recipe, whilst not impacting the taste, texture and sweetness by as much.

Furthermore, it can be seen in FIG. 7 that sweetness is directly correlated with the absence of off-taste. This means that by blending a bulking agent, such as resistant dextrin, having little off-taste, with bulking agents, which may exhibit higher off-taste, the overall sensory profile can be much improved. For instance, in the table above, micronized cocoa shells can be blended with a resistant dextrin as well as sucrose to achieve an overall improved sweetener composition with reduced sugar content.

1. A process for preparing a sweetener composition comprising dry blending one or more crystalline carbohydrate(s) and one or more bulking agent(s) to obtain a sweetener composition having a D90 particle size of 150 microns or less, wherein the bulking agent comprises insoluble fibre, soluble fibre, or combinations thereof.

2. A process according to claim 1, further comprising subjecting the carbohydrate(s) and/or the bulking agent(s) to a particle size reduction technique before dry blending or simultaneously with dry blending.

3. A process according to claim 2, wherein the particle size reduction technique is milling and/or micronization, optionally wherein the technique is cryogenic.

4. A process according to claim 1, wherein the sweetener composition has a D90 particle size of 30 microns or less.

5. A process according to claim 1, wherein the carbohydrate is selected from the group consisting of monosaccharides, disaccharides, and polyols.

6. A process according to claim 1, wherein the carbohydrate is sucrose.

7. (canceled)

8. A process according to claim 1, wherein the insoluble fibre is selected from the group consisting of dietary fibre, cereal bran, oat fibre, bamboo fibre, fruit fibres, sugar beet fibre, sugar cane fibre, tomato fibre, coconut fibre, straw from cereals such as wheat or barley, pea fibre, tea, coffee, potato fibre, cocoa, cocoa powder, bran waste, sugar waste, cocoa waste, corn-cob waste, cellulose, hemi-cellulose, chitosan, mucilages, lignins, compositions comprising the same or combinations thereof.

9. A process according to claim 1 wherein the soluble fibre is selected from the group consisting of resistant dextrin, resistant/modified maltodextrin, polydextrose, β-glucan, galactomannan, fructo-oligosaccharides, gluco-oligosaccharide, galacto-oligosaccharides, MOS (mannose-oligosaccharides), psyllium, inulin, resistant starch, compositions comprising the same or combinations thereof.

10. A process according to claim 1 further comprising adding an anti-caking agent.

11. A process according to claim 1, wherein the sweetener composition does not comprise a surface active agent.

12. A process according to claim 1, wherein the sweetener composition consists essentially of non-porous particles.

13. A process according to claim 1, wherein the sweetener composition consists essentially of bulking agent and crystalline carbohydrate.

14. A sweetener composition obtained or obtainable by the process of claim 1.

15. A food product comprising the sweetener composition of claim 14.

16. (canceled)
